(19) United States
(12) Patent Application Publication
(10) Pub. No.: US 2016/0347544 A1
(43) Pub. Date: Dec. 1, 2016

(54) STORAGE SYSTEM

(71) Applicant: STOREPAL SYSTEMS AS, Haslum (NO)

(72) Inventor: Halvor KVIFTE, Haslum (NO)

(73) Assignee: STOREPAL SYSTEMS AS, Haslum (NO)

(21) Appl. No.: 15/113,876

(22) PCT Filed: Jan. 29, 2015
(86) PCT No.: PCT/NO2015/050020

§ 371 Date: Jul. 25, 2016

(30) Foreign Application Priority Data
Feb. 5, 2014 (NO) 20140140

(51) Int. Cl. B65G 1/06; B65G 1/137; B65G 1/04

(52) U.S. Cl. CPC B65G 1/06; B65G 1/0492; B65G 1/1371

(57) ABSTRACT

Present invention relates to a storage and retrieval facility for storing and retrieving items (3) to and from an overhead storage area comprising a conveyor vehicle (1) for transporting the items (3) to and from the storage said conveyor vehicle (1) is equipped with a detachably integrated elevator (2) to lift the items (3) on the vehicle (1) and then carrying them to the storage area and also to lift the items (3) one above the other in the storage area and vice versa and in that the vehicle (1) is equipped to run in straight lines and change directions, wherein the conveyor vehicle (1) is a rail guided vehicle which is equipped to move along a network of rails comprising straight rails (4) and turning plates (5), the rails being mounted to an attic floor or directly on ceiling joists or on the plenum space above a dropped ceiling.

### TECHNICAL FIELD OF THE INVENTION

The present invention relates to residential or commercial storage, and more specifically, to an indoor type mechanized storage facility, adapted to permit a user to store items in an overhead storage area, accessable from a pick-up point below the storage area.

### BACKGROUND

In view of rising real estate costs, due to urbanization and densification, today's home designs have emphasized maximizing livable floor space. This has resulted in a drastic reduction of available storage space. As a consequence, available storage space is being over-filled, and items previously stored in easily accessed locations are often being pushed into space typically reserved for seldom-used items. Consequently, items are often hard to find, or difficult to access.

Many homes have attic spaces above garages and living quarters, and these attic spaces often provide a storage location for various items. While some attics have livable floor space and have access via a stairwell, most attic spaces remain unfinished, and have more rudimentary access systems, like a foldable ladder attached to a ceiling hatch. A drawback of this access system is that it may be difficult, and even dangerous, to transport items up and down the ladder. The user cannot easily carry the item and grasp the ladder at the same time, thereby forcing a dangerous tradeoff between carrying capacity and safety.

When entering the attic, carrying items to and from a storage location may be both uncomfortable, difficult and dangerous. The headroom may be low, the attic may have inadequate flooring with ceiling joists exposed, the lighting may be insufficient and the temperature may be too high or too low for comfort. Additionally, technical installations such as electrical cables and ventilation ducts, may block access to portions of the attic or may cause tripping.

Many commercial buildings have a dropped ceiling design to make room for piping, wiring and ventilation ducts. This space also represent a significant storage area, but is currently not utilized for storage

Thus, it would be advantageous to provide a storage system, utilizing overhead space that is normally not suitable as livable space, providing an improved way to transport items to and from the storage space, and a system for keeping track of all items stored.

### RELEVANT PRIOR ART

U.S. Pat. No. 7,168,905 B1—Storage and retrieval system.

This patent describes an automated storage shelf unit, moving storage boxes in an endless loop. When increasing the number of storage boxes, the access time and required lift power also increases, and limits the practical maximum storage capacity of the unit. Several units are required to cover most household's storage needs, making such installation very expensive. The integrated raising/lowering feature has too short range to enable overhead storage, and the unit has to occupy livable floor space.

U.S. Pat. No. 4,966,513 A—Indoor type mechanized storage facility.

This patent describes an automated storage system, where a rail-guided vehicle, carrying one box at a time, can access two lines of storage boxes. The storage space may be located below a raised floor, or above the ceiling, e.g. in the attic. This system cannot stack boxes, and only one box can be stored on each side on the vehicle rail. This significantly limits the practical maximum storage capacity of the system, and only a small part of the attic can by utilized for storage. The system involves two complex mechanical devices to move a storage box, a rail guided vehicle and an elevator. In addition, significant construction work is required. In total, such installation would be very expensive.

U.S. Pat. No. 6,202,359 B1—Under floor storage system for building.

This patent describes an automated storage system, involving an endless chain, carrying a limited number of storage boxes, located under the floor. When increasing the number of storage boxes, the access time and required chain power also increases, and limits the practical maximum storage capacity of the unit. The capacity will be too low to cover most household's total storage needs. Large construction work is required to implement this system, and the headroom suffers significantly.

U.S. Pat. No. 6,654,662 B1—Method for organizing the storage of different units. This publication describes an automatic storage device comprising vertically oriented slits where containers are store above each other and a transport device to deliver and retrieve containers to and from the storage area, respectively. The transport device is either a carriage or a portal crane, which is moved above the storage area. This patent describes a system that requires a rigid structure to stack storage boxes in a matrix of columns. All columns have to be at equal height, and rail guided manipulators require additional space on top of the matrix structure. This design is not well suited for attic storage, since height varies, and in general is limited.

Patent JP 2003-049534—Storage device for attic space.

This patent describes an automated storage system, involving an endless chain, carrying a limited number of storage boxes, overhead in an attic storage space. When increasing the number of storage boxes, the access time and required chain power also increase, and limits the practical maximum storage capacity of the unit. The capacity will be too low to cover most household's total storage needs. The pick-up-point for storage boxes has to be adjacent to the storage space, and at the same level. This makes this design unsuited for overhead storage, such as traditional attic layout or dropped ceiling designs.

Patent JP 07-002319—Storage Device.

This patent describes an automated storage system, involving an endless chain, carrying a limited number of storage boxes. When increasing the number of storage boxes, the access time and required chain power also increase, and limit the practical maximum storage capacity of the unit. The capacity will be too low to cover most household's total storage needs. The pick-up-point for storage boxes is close to the ceiling, making the boxes difficult to reach, and significantly limiting maximum load of stored items.

Patent JP 2008-169614—Storage in building (EP 2309075 A1).

This patent describes an automated storage system, where a rail-guided vehicle, carrying one box at a time, can access several lines of storage boxes. The vehicle moves the storage box to an elevator device, lifting or lowering the box to a pick-up point, easily accessible for the user. This system cannot stack boxes, and the vehicle requires dead space for every second row of boxes for loading and unloading. This limits the practical maximum storage capacity of the system. The system involves two complex mechanical devices to move a storage box, a rail guided vehicle and an elevator. In addition, significant construction work is required. In total, such installation will be very expensive.

Patent EP 0675059 A2—Storage apparatus.

This patent describes an automated storage unit, moving storage boxes in an endless loop, typically installed below the kitchen floor. When increasing the number of storage boxes, the access time and required power also increases, and limits the practical maximum storage capacity of the unit. To pick up storage boxes, the user has to reach down below floor level. This significantly limits maximum load of stored items.

DE 2629718 describes a storage device comprising crane devices movable on rails and a transversal rail.

DE 102009051800 describes a storage carriage, which is moved above the storage area, comprising a lifting board. The direction of movement of the carriage can be altered by means of a rotating board.

U.S. Pat. No. 6,071,063 and US 2012321423 describe automatic storage carriages with wheels that can rotate around a vertical axis to change the travel direction of the carriage.

FR 2730715 describes an automatic storage carriage comprising two sets of wheels that can be moved in two travel directions.

WO 2007132272 and JP 2001294304 both describe a device for transporting goods to and from an attic.

### BRIEF DESCRIPTION OF THE INVENTION

The invention concerns methods and equipment for organizing objects in a storage space, consisting of a multitude of self-supported stacks of standardized containers, and for moving containers between the storage space and a designated pick-up point, easy accessible for the user.

In a preferred embodiment of this invention, the storage space is an attic, and a pick-up point for storage containers is located in the living area below the attic.

More particularly, the invention provides a rail-guided vehicle, supported by four wheels, and equipped with an integrated container elevator to lift storage containers. The rail-guided vehicle can run in straight lines, and rotate to change direction.

The rail-guided vehicle moves along a system of straight rails, and rails for turning. The rails are mounted on a floor or directly to the ceiling joists if no flooring is available.

One preferred embodiment of this patent includes a modified attic ladder with attached guide rails. When positioned above this ladder, the integrated container elevator on the rail-guided vehicle can travel down the ladder, until pick-up position has been reached.

All movements are monitored and controlled by a control system, integrated in the rail-guided vehicle on-board computer system. This computer system also includes an inventory control system, a service application and a user interface connected to a handheld digital communication unit, such as a smart phone or a tablet PC.

By sharing inventory information, certain objects may be offered for sale, rental or pooling.

These and other objectives are achieved according to the invention with a storage and retrieval facility for storing and retrieving items to and from an overhead storage area comprising a conveyor vehicle for transporting the items to and from the storage said conveyor vehicle is equipped with a detachably integrated elevator to lift the items on the vehicle and then carrying them to the storage area and also to lift the items one above the other in the storage area and vice versa and in that the vehicle is equipped to run in straight lines and change directions, wherein the conveyor vehicle is a rail guided vehicle which is equipped to move along a network of rails comprising straight rails and turning plates, said rails being mounted to an attic floor or directly on ceiling joists or on the plenum space above a dropped ceiling.

A position sensor is preferably located on the rail guided vehicle to give the precise position to the vehicle for stopping at a turning plate, just prior to rotation, and during rotation to give a precise orientation.

The vehicle has preferably a turning motor, which, in the event of positioning of the vehicle for rotation, rotates a turning rod trigger, to turn all four wheels to tangent the same turning path circle.

Each of the rear wheels is preferably connected to a separate propulsion motor, through a hexagonal driveshaft and a ball joint, which allows the rear wheels to turn in the event of positioning of the vehicle for rotation as well as to run in the same direction when moving straight, and in opposite directions during rotation.

One propulsion motor preferably runs both or all wheels, and a mechanism triggered by the turning motor, shifts the rotation direction for the wheels to be reversed during turning.

The integrated elevator can preferably separate from the vehicle and move up and down along a ladder independent of the vehicle for carrying items between the pick up point and the vehicle.

### SHORT DESCRIPTION OF THE DRAWINGS

The invention will in the following be explained more in detail with a non-limiting exemplary embodiment, with reference to the accompanying drawings, where:

FIG. 1 shows an overview of one possible storage system implementation.

FIG. 2 shows the rail-guided vehicle in drive position.

FIG. 3 shows the rail-guided vehicle in turning configuration.

FIG. 4 shows the integrated container elevator for the rail-guided vehicle.

FIG. 5 shows the rail-guided vehicle when placing a storage container in a storage position.

FIG. 6 shows the rail-guided vehicle when stacking one storage container on top of another storage container.

FIG. 7 shows the rail-guided vehicle with an integrated container elevator extended into rails attached to an attic ladder.

FIG. 8 shows how the ladder rail folds with a foldable attic ladder.

FIG. 9 shows the integrated container elevator when moving between the rail-guided vehicle and rails attached to an attic ladder.

FIG. 10 shows the system layout.

FIG. 11 shows the container storage process.

FIG. 12 shows the container retrieval process

FIG. 13 shows the storage optimization process.

### DETAILED DESCRIPTION OF PREFERRED EMBODIMENTS OF THE INVENTION

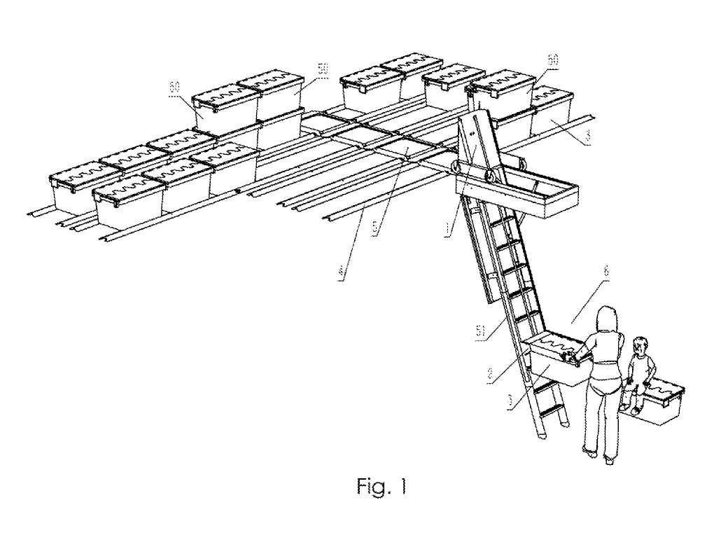

FIG. 1 shows an implementation if the invention where a network of straight rails (4) and turning plates (5) are mounted to an attic floor, giving a rail guided vehicle (1) access to a number of storage positions, where containers can be stored in vertical container stacks (50) by using a modified attic ladder (51), the integrated container elevator (2) in the rail-guided vehicle (1) can transport storage containers (3) between the storage area and a pick-up point (6) in the living area below the attic. In another embodiment of the invention, the attic has no flooring, and straight rails (4) and turning plates (5) are mounted directly on ceiling joists. In yet another embodiment of the invention, the storage area is located in the plenum space above a dropped ceiling.

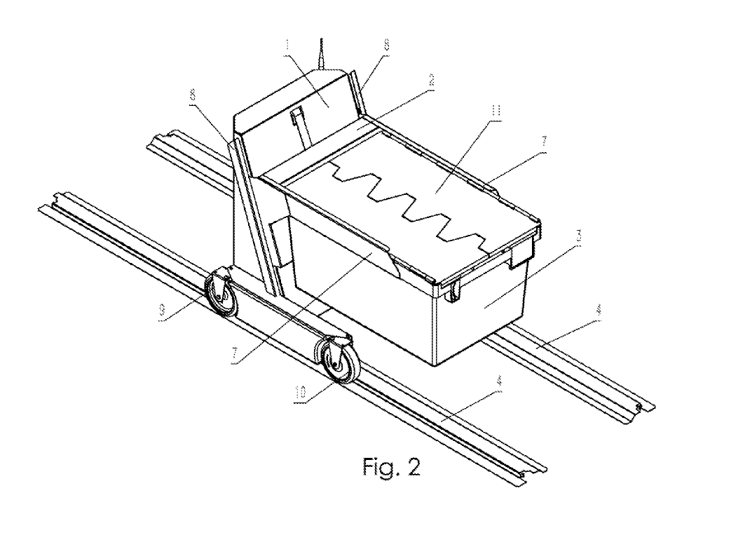

In FIG. 2, the rail-guided vehicle (1) is shown in driving position, moving along a pair of straight rails (4), supported by four vehicle wheels (9,10). In a preferred embodiment of this invention, the vehicle rear wheels (9) are driving the vehicle, and the front wheels (10) are running freely. A four-wheel drive configuration is another possible embodiment of the invention. An integrated container elevator (2) enables the rail-guided vehicle (1) to lift and carry a storage container (3). In a preferred embodiment of this invention, the storage container (3) is a standardized attached lid container. The storage container (3) is engaged in the container engagement profiles (7), which are extended C-profiles from the base of the integrated container elevator (2). This engagement requires the storage container lids (11) to be closed, since the guiding rim of the storage container (3) will only fit with the container engagement profiles (7) when container lids (11) are closed. This design makes the user always close the storage container lids (11), preventing the system from stacking open storage containers (3), which would result in unpredictable storage positions, and possible jamming. The integrated container elevator (2) is guided by the integrated elevator rails (8), which are C-profiles mounted on each side the rail-guided vehicle (1).

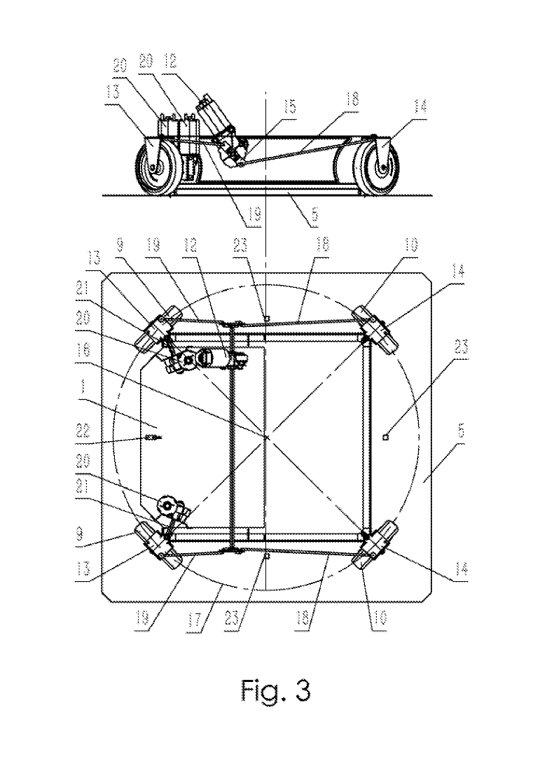

FIG. 3 shows the rail-guided vehicle (1) in turning configuration. To change direction, the rail-guided vehicle has to stop at a turning plate (5). A position sensor (22) gives the correct stop position. In a preferred embodiment of the invention, punched position holes (23) in the sheet metal turning plates (5), are detected by use of an inductive position sensor (22) located on the rail-guided vehicle (1).

When positioned for rotation, a turning motor (12) rotates the turning rod trigger (15), pushing and pulling front turning rods (18) and rear turning rods (19) causing front wheel modules (14) and rear wheel modules (13) to turn all four wheels (9, 10) to tangent the same turning path (17) circle. To turn the rail-guided vehicle (1), two wheels have to rotate clockwise, and to wheels counter-clockwise. In a preferred embodiment of the invention, each of the rear wheels (9) is connected to a separate propulsion motor (20), through a hexagonal driveshaft (21) and a ball joint allowing the rear wheels (9) to turn, running the same direction when moving straight, and opposite directions during rotation. In another embodiment of the invention, one propulsion motor (20) runs both or all wheels, and a mechanism trigged by the turning motor (12) shifts the rotation direction for the wheels (9, 10) to be reversed during turning. A position hole (23) is located at every valid stop position along the turning path (17), enabling the position sensor (22) to detect an accurate stop position. When turning is completed, front wheels (10) and rear wheels (9) are turned back to parallel orientation, and the rail-guided vehicle (1) is ready to continue in a straight direction. In another embodiment of the invention, a pivoting shaft on the rail-guided vehicle (1) is being engaged in a center hole located concentric to the turning pivot axis (16) in the turning plate (5), to ensure consistent rotation axis position.

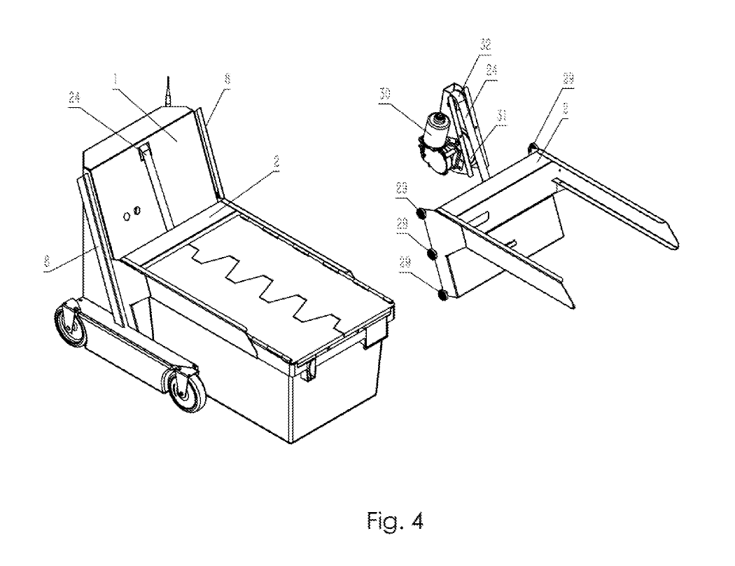

FIG. 4 shows the integrated container elevator (2) with a self-locking elevator motor (30) driving an elevator drum (31), winding up the elevator belt (24), pulling a cart upwards towards the return roller (32) located at the top of the rail-guided vehicle (1). The cart runs on elevator castors (29), three on each side, guided by the integrated elevator rails (8) mounted on each side of the rail-guided vehicle (1). To lower the integrated container elevator (2), the elevator motor (30) reverses the elevator drum (31), and the elevator cart is pulled downwards by gravity along the integrated elevator rails (8).

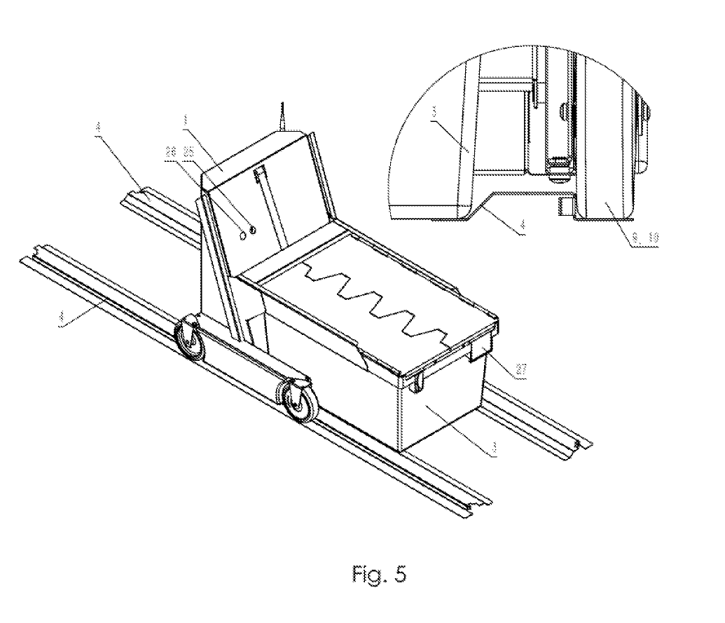

In FIG. 5, the rail-guided vehicle (1) is shown, placing a storage container (3) in a storage position. A storage container (3) can be stored anywhere along a straight rail (4). The rail profile has guiding features for the front wheels (10) and the rear wheels (9) for the rail-guided vehicle (1), and for storage containers (3). This design implies a very short chain of tolerances, and ensures precise transversal positioning of storage containers (3). To obtain acceptable longitudinal tolerances, an integrated distance sensor (25) calculates the distance to the storage container (3) during pick-up from storage. In another embodiment of the invention, the rail-guided vehicle (1) is not supported by rails, and travels directly on a floor, following markers or wires in the floor, or uses vision or lasers. To identify the storage containers (3), container labels (27) are attached to the storage containers (3). One section of the container label (27) is reserved for a barcode; the rest of the container label (27) is reserved for information added by the user in handwriting. The barcode is read by the integrated barcode reader (26) when the storage container (3) is lifted by the rail-guided vehicle (1), to a height where the integrated barcode reader (26) aligns with the barcode. To be independent of container orientation, identical container labels (27) are attached to both short sides of the storage container (3). In the section of the container label (27) reserved for handwriting, the user may write a title for the storage container (3), for easy identification. This is particularly convenient when more than one storage container (3) is outside the storage space at the same time. Label material and marker specification should be similar to whiteboard systems to make it possible to wipe out, and change title when desired by the user.

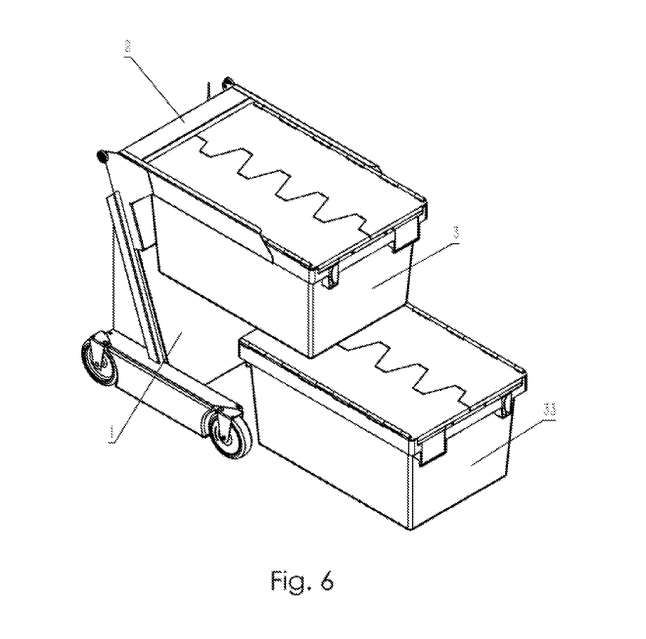

FIG. 6 shows that the integrated container elevator (2) makes the rail-guided vehicle (1) capable of lifting a storage container (3) a little more than the height of one storage container (3). This makes it possible to lift and place one storage container (3) on top of another storage container (3), and build self-supported stacks by repeatedly lifting the undermost storage container (33) on top of the next. This process can be reversed, by repeatedly lowering the storage containers (3) placed on top of the undermost storage container (33). The maximum height of such container stacks are only limited by available headroom, stability of the stack, and total weight.

Due to the slanted elevator slope (8), storage containers (3) may be stored horizontally with no gaps in between, avoiding the typical behavior of a storage container (3) hanging or climbing on the adjacent storage container (3), when the elevator slope is vertical.

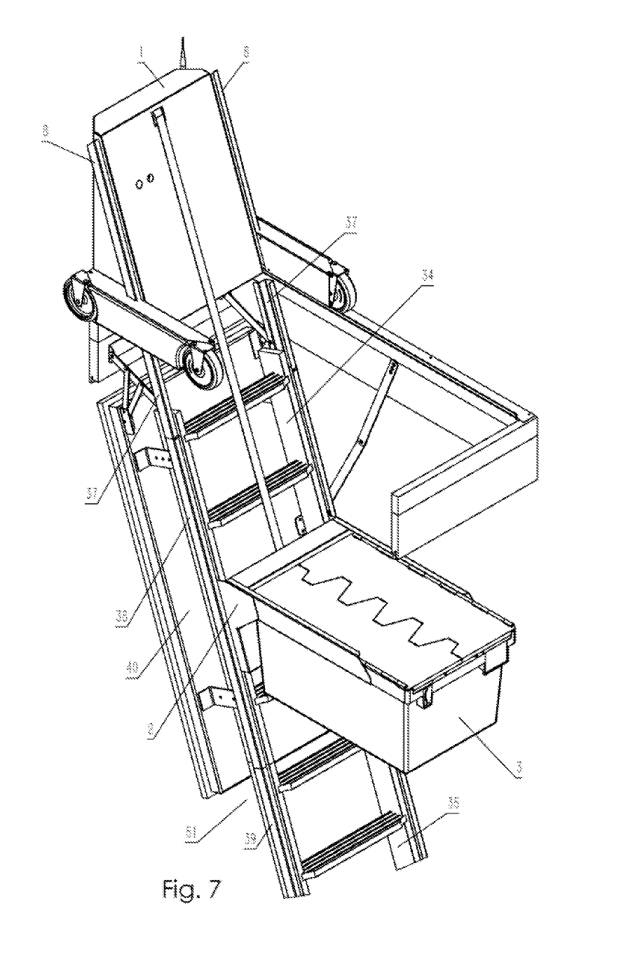

In FIG. 7, the rail-guided vehicle (1) is shown positioned above an open attic hatch (40), with the integrated container elevator (2) lowered along the attic ladder (51). In a preferred embodiment of the invention, the attic ladder (51) is a manual foldable three-segment ladder, with elevator rails (37, 38, 39) attached to the two upper ladder segments (34, 35). In another embodiment of the invention, the attic ladder (51) is automatically retractable, controlled by the control system. The elevator rails (37, 38, 39) are attached outside the attic ladder stringers, making it possible to manually enter the attic with over-sized objects for storing, or for service.

The integrated elevator rails (8) on the rail-guided vehicle (1) are slanted at the same angle as the attic ladder (51) to ensure correct orientation of the storage container (3) when being lowered from the rail-guided vehicle (1), and down the attic ladder (51). In another embodiment of the invention, the slant angle on the rail-guided vehicle (1) may be different from the attic ladder angle, and means to compensate for the slope angle difference are integrated in the integrated container elevator (2). In yet another embodiment of the invention, the integrated container elevator (2) travels vertically, e.g. inside a cupboard, or along rails mounted on a wall in the living area below the attic, requiring the integrated elevator rails (8) to be vertical. In yet another embodiment of the invention, the slope angle for the integrated elevator rails (8) is configurable, making it possible to set up the rail-guided vehicle (1) for different elevator guide configurations.

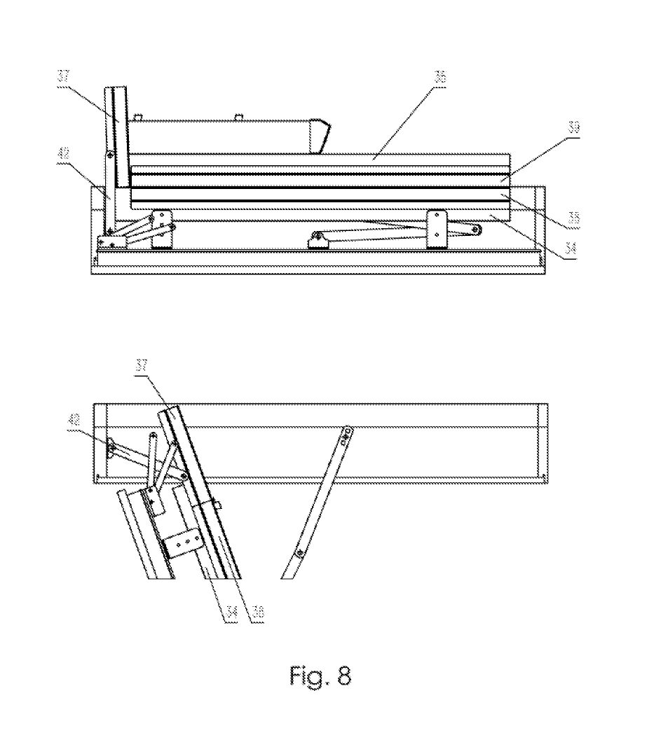

In FIG. 8, the integration of elevator rails (37, 38, 39) on the attic ladder (51) is shown. In a preferred embodiment of the invention, the attic ladder (51) is a three segment folding ladder, where the lower elevator rails (39) are fixed to the middle ladder segment (35), and the middle elevator rails (38) are fixed to the upper ladder segment (34). The upper elevator rails (37) are linked to elevator rail folding links (42), and folds to a vertical orientation during folding of the attic ladder (51). In another embodiment of the invention, the elevator rails are guided directly by the ladder stringers.

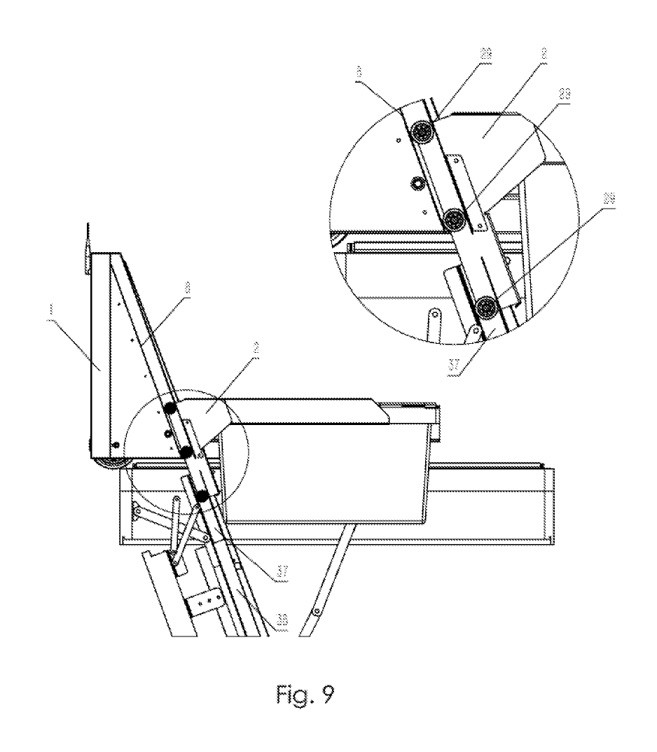

FIG. 9 shows the shift from guiding the integrated container elevator (2) on integrated elevator rails (8) on the rail-guided vehicle (1), to guiding on the upper elevator rails (37). When lowering the integrated container elevator (2), the lower pail of elevator castors (29) leave the integrated elevator rail (8), and travels unsupported until the upper elevator rails (37) are reached. During the unsupported travel, the upper two pair of elevator castors (29) are supported by the integrated elevator rails (8). When lowering the integrated container elevator (2) further, the middle pair of elevator castors (29) are unsupported. In this situation, the upper pail or elevator castors (29) are supported by the integrated elevator rails (8), and the lower pair of elevator castors (29) are supported by the upper elevator rails (37). When the upper pair of elevator castors (29) are unsupported, the lower two pair of elevator castors (29) are supported by the upper elevator rails (37) and the middle elevator rails (38). This arrangement ensures at least two pair of elevator castors (29) to be supported at all times, keeping the integrated container elevator (2) from tilting when traveling down the attic ladder (51).

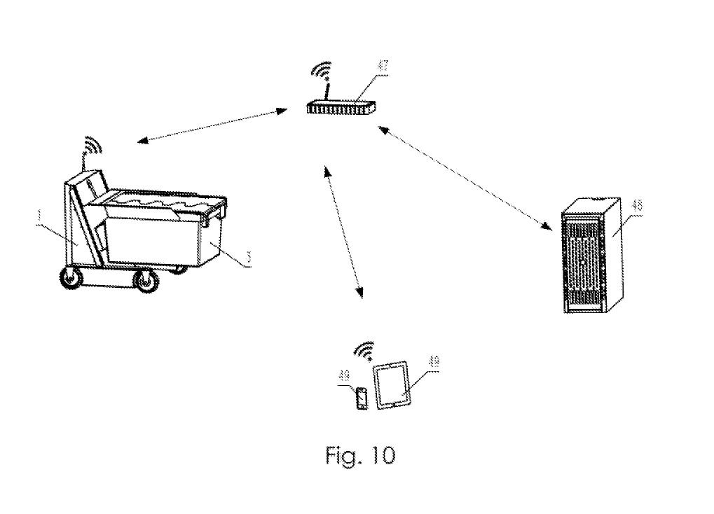

FIG. 10 shows a preferred system layout for the invention. The rail-guided vehicle (1) includes an on-board computer, running movement control software, a storage inventory database, a web-based user-interface and diagnostic and service software. The on-board computer communicates wirelessly over Wi-Fi with a router (47), connecting wirelessly over Wi-Fi to handheld devices (49), and over the internet to a remotely located service center (48). In another embodiment of the invention, the on-board computer communicates directly to the handheld device (49) over Wi-Fi. In yet another embodiment of the invention, the handheld device (49) is replaced by a wall mounted user panel. The user interacts with the system by browsing the web-based user-interface on a handheld device (49). The user-interface gives access to the storage inventory database, and to request retrieval or storage of storage containers (3). A service technician on site can get access to service functions using a handheld device (49), using a restricted service section of the web-based interface. For on-line diagnostics, the user may grant access to the system over the internet, for a service technician from a remotely located service center (48). Back-up of site-specific software on the on-board computer is stored on a server at the service center (48). In another embodiment of the invention, back-up can be stored on a local computer or network storage device, a handheld device (49) or at a third party internet storage provider.

By sharing inventory information, certain objects may be tagged for sale, rental or pooling. This information is shared with other users of automatic storage systems, or is published on third-party online market places like eBay. To ensure security and privacy, all requests for objects are handled anonymously by the system, and contact information will only be given if owner permits, for each case separately.

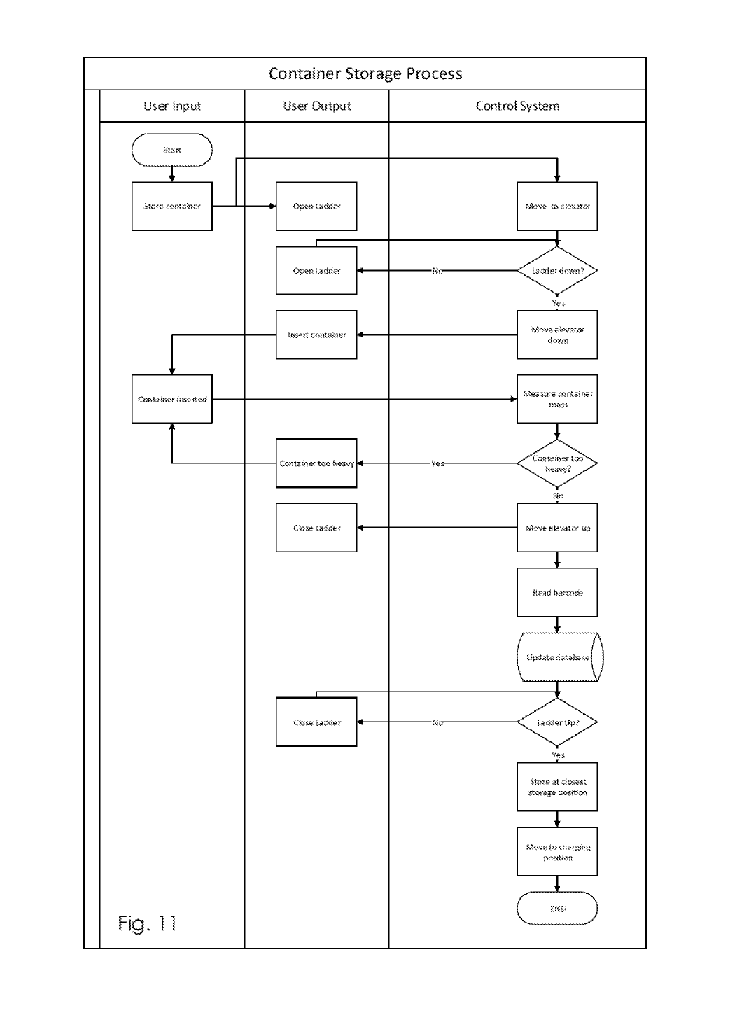

FIG. 11 shows the container storage process, from the user initiates the process by requesting a storage container (3) to be picked up for storage, until the storage container (3) is stored in the storage space, and the rail-guided vehicle (1) has returned to the charging position. All user inputs are given by the user pushing virtual buttons on a handheld device (49), and all user outputs are given to user as messages on the handheld device (49).

The rail-guided vehicle (1) is able to detect if the attic ladder has been opened or not. This makes it possible for the control system to verify if the user has performed this manual operation, and send user output reminders until the attic ladder is opened, and ready to use as container elevator.

When lifting a storage container (3) from the pick-up point (6), the control system in the rail-guided vehicle (1) measures the electric current in the elevator motor (30). The electric current is proportional to the motor torque and the lifting load, making it possible to determine the mass of the storage container (3). A calibration can be performed by lifting an object with a known mass, e.g. an empty elevator cart. This information is used by the control system to reject over-loaded storage containers (3), to protect the system and to educate the user to avoid container loads heavier than recommended for human handling.

When a storage container (3) has been placed on an available storage position, storage date, storage container title, content, and measured weight is recorded in the storage inventory database. If a storage container contains objects with an expiration date, e.g. food, wine or medicines, the control system will provide a warning when the expiration date is close to expire. Furthermore, the inventory control system can provide a warning for storage containers (3) not accessed for a long time, to consider removing from storage space, and recycle.

The rail-guided vehicle (1) always returns to the charging position when not busy, to ensure maximum capacity at all times.

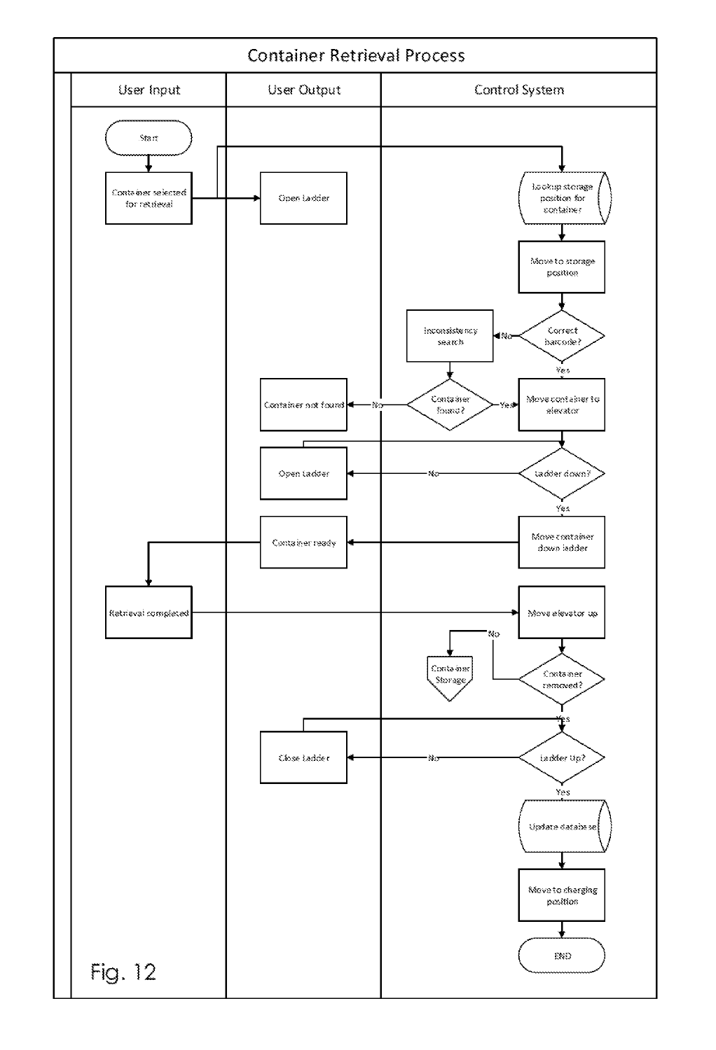

FIG. 12 shows the container retrieval process, from the user initiates the process by requesting retrieval of a storage container (3), until the storage container (3) is picked-up by the user, and the rail-guided vehicle (1) has returned to the charging position. All user inputs are given by the user pushing virtual buttons on a handheld device (49), and all user outputs are given to user as messages on the handheld device (49). When a storage container (3) is requested, the system finds the storage location in the storage space by looking-up the identification number for the storage container (3) in the storage inventory database. When picking up the storage container at the found storage location, the control system checks the container label (27) barcode to verify that the requested storage container (3) has not been moved manually. If the barcode does not match the identification number for the requested storage container (3), an inconsistency search will be performed, systematically reading all barcodes to find the missing storage container (3), and continue the container retrieval process. If the requested storage container (3) is not found, a user message is given to the handheld device (49).

When the requested storage container (3) has been delivered to pick-up point, the user has to remove the storage container (3), and push a virtual button on the handheld device (49) to make the integrated container elevator (2) return to the rail-guided vehicle (1). If the control system detects that the storage container (3) has not been removed, the control system will return the storage container (3) to the storage space. Then retrieval date will be added to the storage inventory database, and the rail-guided vehicle (1) returns to the charging position to ensure maximum capacity at all times.

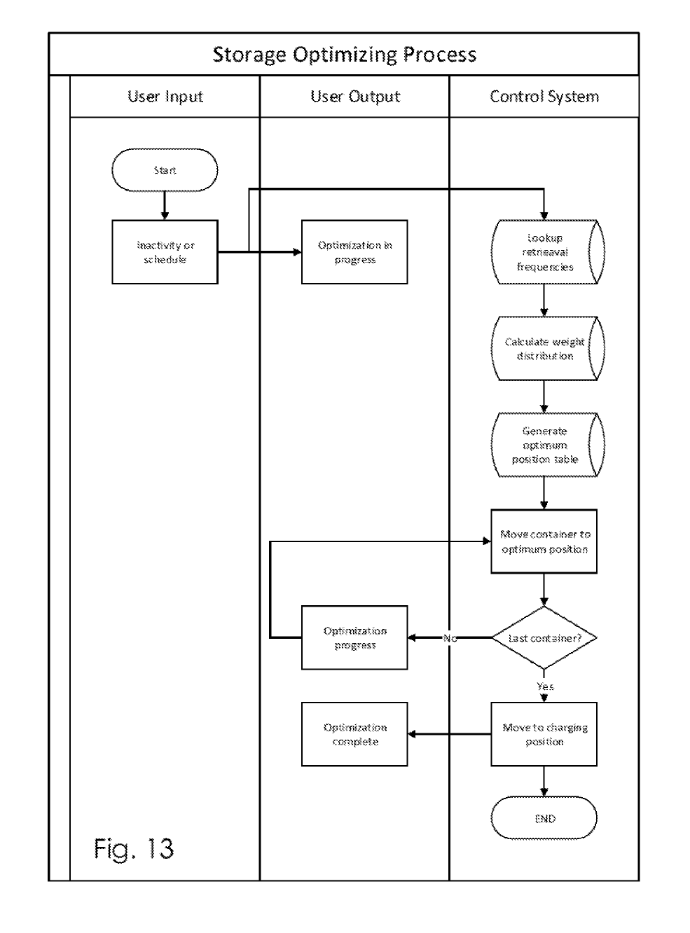

FIG. 13 shows the storage optimizing process, running whenever system is not busy, optionally at scheduled times, if storage space is not already optimized. The control system uses information recorded in the storage inventory database to optimize storage locations for the storage containers (3). Information regarding storage container retrieval frequencies and sequence patterns, is used to minimize retrieval times. Storage containers (3) often requested are located close to the attic hatch (40), and storage containers (3) often requested in sequence are stored in stacks.

The mass of each storage container (3) is recorded in the storage inventory database, and the control system use this information to prevent too high loads locally for the building structure, and ensure an even load distribution. The system also use this information to prevent damage to the undermost storage containers (33) in a stack, and to ensure manageable loads on stacks for the integrated container elevator (2).

When the optimization calculation is completed, the rail-guided vehicle (1) starts reorganizing the storage space, moving each storage container (3) to the optimum location. If the user initiates use of the system, the storage optimization process will be temporarily postponed, and will continue when the user requests have been completed. When all storage containers (3) are located in the optimum location, the rail-guided vehicle (1) returns to the charging position to ensure maximum capacity at all times.

1. A storage and retrieval facility for storing and retrieving items to and from an overhead storage area, the storage and retrieval facility comprising:
a conveyor vehicle for transporting the items to and from the storage;
wherein said conveyor vehicle is equipped with a detachably integrated elevator to lift the items on the vehicle and carry the items to the storage area and to lift the items one above the other in the storage area and vice versa;
wherein the vehicle is equipped to run in straight lines and change directions; and
wherein the conveyor vehicle is a rail guided vehicle equipped to move along a network of rails comprising straight rails and turning plates, the rails being mounted to an attic floor or directly on ceiling joists or on the plenum space above a dropped ceiling.

2. The storage and retrieval facility according to claim 1,
wherein a position sensor is located on the rail guided vehicle to give the precise position to the vehicle for stopping at a turning plate, just prior to rotation, and during rotation to give a precise orientation.

3. The storage and retrieval facility according to claim 1,
wherein the vehicle has a turning motor, which, in the event of positioning of the vehicle for rotation, rotates a turning rod trigger, to turn all four wheels to tangent the same turning path circle.

4. The storage and retrieval facility according to claim 1, wherein each of the rear wheels is connected to a separate propulsion motor through a hexagonal driveshaft and a ball joint, which allows the rear wheels to turn in the event of positioning of the vehicle for rotation as well as to run in the same direction when moving straight, and in opposite directions during rotation.

5. The storage and retrieval facility according to claim 1, wherein, one propulsion motor runs both or all wheels, and a mechanism triggered by the turning motor, shifts the rotation direction for the wheels to be reversed during turning.

6. The storage and retrieval facility according to claim 1, wherein the integrated elevator can separate from the vehicle and move up and down along a ladder independent of the vehicle for carrying items between the pick up point and the vehicle.
